(19) United States
(12) Patent Application Publication
(10) Pub. No.: US 2021/0352987 A1
(43) Pub. Date: Nov. 18, 2021

(54) WATER ACTIVATED EYELASH

(71) Applicant: Wengang Guan, Qingdao City (CN)

(72) Inventor: Wengang Guan, Qingdao City (CN)

(21) Appl. No.: 17/137,360

(22) Filed: Dec. 30, 2020

(30) Foreign Application Priority Data
May 16, 2020 (CN) 202010415917.3

(51) Int. Cl. A41G 5/02; C09J 11/04; C09J 11/06; C09J 143/04; C09J 7/35; C09J 7/24; C09J 7/29

(52) U.S. Cl. CPC A41G 5/02; C09J 11/04; C09J 11/06; C09J 143/04; C09J 7/35; C09J 7/241; C09J 2401/00; C09J 2463/00; C09J 2433/00; C09J 2429/00; C09J 2407/00; C09J 2421/006; C09J 7/29

(57) ABSTRACT

The invention discloses a water activated eyelash, comprising a water activated bonding layer, a glue fixing layer, a soft support, and eyelash bodies, wherein the soft support is made of rubber to form a strip structure with a groove on one side; one end of each of the several eyelash bodies passes through the other side of the soft support and is fixed by the glue fixing layer at the bottom of the groove, and the corresponding groove on the outside of the glue fixing layer is further provided with a water activated bonding layer; by arranging the water activated bonding layer, the water activated bonding layer is wiped with water when in use so that it is changed from non-sticky to sticky. The invention provides a false eyelash that can be sticky when exposed to water, thereby reducing pollution and being convenient to use.

### BACKGROUND OF THE INVENTION

### 1. Field of the Invention

The invention relates to a false eyelash, in particular to a water activated eyelash.

### 2. Description of the Related Art

False eyelashes are artificial eyelashes used to beautify the eyes. Generally, the eyelashes are lengthened and thickened to make the eyes look bigger, brighter, fuller, and more energetic. False eyelashes have been in existence for a long time, and records of false eyelashes can be found in ancient Egyptian and Roman literature as early as 2000 B C. The materials used to make false eyelashes include plastic, cotton, feathers and other materials. With the use of different materials, the effect of false eyelashes is also different.

At present, the method of combining false eyelashes with human eyes is still adhesive sticker, which is uncomfortable and irritating to human skin, and may cause damage to human eyelids when removing makeup.

### SUMMARY OF THE INVENTION

The purpose of the invention is to provide a water activated eyelashes to solve the problems raised in the prior art.

In order to achieve the above purpose, the invention provides the following technical solutions:

a water activated eyelash, comprising a water activated bonding layer, a glue fixing layer, a soft support, and eyelash bodies, wherein the soft support is made of rubber to form a strip structure with a groove on one side; one end of each of the several eyelash bodies passes through the other side of the soft support and is fixed by the glue fixing layer at the bottom of the groove, and the corresponding groove on the outside of the glue fixing layer is further provided with a water activated bonding layer; by arranging the water activated bonding layer, the water activated bonding layer is wiped with water when in use so that it is changed from non-sticky to sticky.

Further, a number of pinholes are opened on the water activated bonding layer. The purpose of the pinholes is to enable the water activated bonding layer to have space to participate in deformation and thus better deform. At the same time, the pinholes can store a little water to achieve a long-term moisturizing effect, thereby ensuring viscosity.

Further, the soft support is made of transparent rubber material.

Further, the raw materials of the water activated bonding layer mainly comprise the following components in parts by weight: 40-50 parts of silicone acrylic emulsion, 30-40 parts of hydrophobic epoxy resin, 10-20 parts of natural rubber, 8-10 parts of potassium citrate, 3-5 parts of nano zinc oxide, 7-9 parts of sodium hydroxymethyl cellulose, 10-12 parts of polyvinyl alcohol, 20-30 parts of polymer resin, 10-12 parts of honeycomb calcium carbonate, 8-10 parts of color developing agent, 8-10 parts of chromogenic agent, and 5-7 parts of desensitizer.

In the invention, the silicone-acrylic emulsion, the hydrophobic epoxy resin, the natural rubber, the potassium citrate, the nano zinc oxide, the sodium hydroxymethyl cellulose, the polyvinyl alcohol, and the polymer resin are used to form a material that can produce viscosity when it meets water, and it will not dissipate after long time soaking in water; in addition, the polymer resin, the honeycomb calcium carbonate, the color developing agent, the chromogenic agent, and the desensitizer can develop color when exposed to water; the matching of different colors can meet the needs of users, and at the same time, the color rendering can be used as a good distinction, so that users can understand whether it is sticky to be used.

Further, when it is need to remove makeup, use a hair dryer to blow the false eyelashes in the hot air mode, which can be quickly removed, and close eyes when blowing.

Compared with the prior art, the invention has the advantageous effects that: the invention provides a false eyelash that can be sticky when exposed to water, thereby reducing pollution and being convenient to use.

The bonding material used in the invention has no irritation to the skin, and at the same time can change color when exposed to water to play a distinguishing effect, which is very convenient to wear and remove.

### BRIEF DESCRIPTION OF THE DRAWINGS

FIG. 1 is a schematic diagram of the water activated eyelash.

In the FIGURE, 1 refers to the water activated bonding layer; 2 refers to the glue fixing layer; 3 refers to the soft support; 4 refers to the eyelash body; 5 refers to the pinhole.

### DETAILED DESCRIPTION OF THE PREFERRED EMBODIMENTS

The technical solutions in the embodiments of the invention will be clearly and completely described hereinafter with reference to the embodiments of the invention. Obviously, the described embodiments are only a part of the embodiments of the invention, rather than all the embodiments. Based on the embodiments of the invention, all other embodiments obtained by those of ordinary skill in the art without creative efforts shall all fall within the protection scope of the invention.

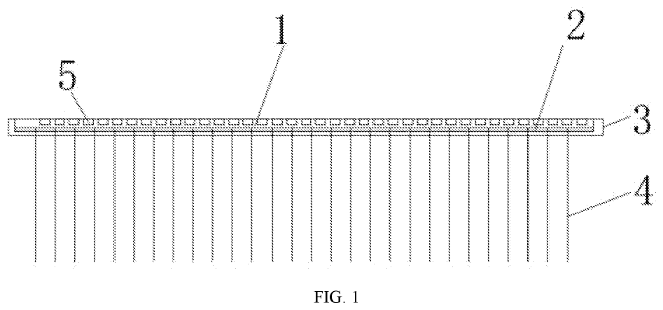

With reference to FIG. 1, in the embodiment of the invention, water activated eyelash, comprising a water activated bonding layer 1, a glue fixing layer 2, a soft support 3, and eyelash bodies 4, wherein the soft support 3 is made of rubber to form a strip structure with a groove on one side; one end of each of the several eyelash bodies 4 passes through the other side of the soft support and is fixed by the glue fixing layer 2 at the bottom of the groove, and the corresponding groove on the outside of the glue fixing layer 2 is further provided with a water activated bonding layer 1; by arranging the water activated bonding layer, the water activated bonding layer is wiped with water when in use so that it is changed from non-sticky to sticky, so that it can be used.

A number of pinholes 5 are opened on the water activated bonding layer 1. The purpose of the pinholes 5 is to enable the water activated bonding layer 1 to have space to participate in deformation and thus better deform. At the same time, the pinholes 5 can store a little water to achieve a long-term moisturizing effect, thereby ensuring viscosity.

### Embodiment 1

The raw materials of the water activated bonding layer 1 mainly comprise the following components in parts by weight: 40 parts of silicone acrylic emulsion, 30 parts of hydrophobic epoxy resin, 10 parts of natural rubber, 8 parts of potassium citrate, 3 parts of nano zinc oxide, 7 parts of sodium hydroxymethyl cellulose, 10 parts of polyvinyl alcohol, 20 parts of polymer resin, 10 parts of honeycomb calcium carbonate, 8 parts of color developing agent, 8 parts of chromogenic agent, and 5 parts of desensitizer.

### Embodiment 2

The raw materials of the water activated bonding layer 1 mainly comprise the following components in parts by weight: 45 parts of silicone acrylic emulsion, 35 parts of hydrophobic epoxy resin, 15 parts of natural rubber, 9 parts of potassium citrate, 4 parts of nano zinc oxide, 8 parts of sodium hydroxymethyl cellulose, 11 parts of polyvinyl alcohol, 25 parts of polymer resin, 11 parts of honeycomb calcium carbonate, 9 parts of color developing agent, 9 parts of chromogenic agent, and 6 parts of desensitizer.

### Embodiment 3

The raw materials of the water activated bonding layer 1 mainly comprise the following components in parts by weight: 50 parts of silicone acrylic emulsion, 40 parts of hydrophobic epoxy resin, 20 parts of natural rubber, 10 parts of potassium citrate, 5 parts of nano zinc oxide, 9 parts of sodium hydroxymethyl cellulose, 12 parts of polyvinyl alcohol, 30 parts of polymer resin, 12 parts of honeycomb calcium carbonate, 10 parts of color developing agent, 10 parts of chromogenic agent, and 7 parts of desensitizer.

In the description of the invention, it should be noted that the terms “installed” and “connected” should be understood in a broad sense, unless otherwise clearly defined and limited; for example, it can be a fixed connection, a detachable connection, or an integral connection; it can be a mechanical connection or an electrical connection; it can be a direct connection, or an indirect connection through an intermediate medium, and it can be an internal communication between two components. For those of ordinary skill in the art, the specific meaning of the above terms in the invention can be understood through specific situations.

Although the invention has been described in detail with reference to the foregoing embodiments, it is still possible for those skilled in the art to modify the technical solutions described in the foregoing embodiments, or equivalently replace some of the technical features. Any modification, equivalent replacement, improvement, etc., made within the spirit and principle of the invention shall be included in the protection scope of the invention.

1. A water activated eyelash, comprising a water activated bonding layer (1), a glue fixing layer (2), a soft support (3), and eyelash bodies (4), wherein the soft support (3) is made of rubber to form a strip structure with a groove on one side; one end of each of the several eyelash bodies (4) passes through the other side of the soft support and is fixed by the glue fixing layer (2) at the bottom of the groove, and the corresponding groove on the outside of the glue fixing layer (2) is further provided with a water activated bonding layer (1); by arranging the water activated bonding layer, the water activated bonding layer is wiped with water when in use so that it is changed from non-sticky to sticky.

2. The water activated eyelash according to claim 1, wherein a number of pinholes (5) are opened on the water activated bonding layer (1).

3. The water activated eyelash according to claim 1, wherein the soft support (3) is made of transparent rubber material.

4. The water activated eyelash according to claim 1, wherein the raw materials of the water activated bonding layer comprise the following components in parts by weight: 40-50 parts of silicone acrylic emulsion, 30-40 parts of hydrophobic epoxy resin, 10-20 parts of natural rubber, 8-10 parts of potassium citrate, 3-5 parts of nano zinc oxide, 7-9 parts of sodium hydroxymethyl cellulose, 10-12 parts of polyvinyl alcohol, 20-30 parts of polymer resin, 10-12 parts of honeycomb calcium carbonate, 8-10 parts of color developing agent, 8-10 parts of chromogenic agent, and 5-7 parts of desensitizer.

5. The water activated eyelash according to claim 1, wherein when it is need to remove makeup, use a hair dryer to blow the false eyelashes in the hot air mode, which can be quickly removed, and close eyes when blowing.
